(19) United States
(12) Patent Application Publication
(10) Pub. No.: US 2021/0382988 A1
(43) Pub. Date: Dec. 9, 2021

(54) ROBUST MONITORING OF COMPUTER SYSTEMS AND/OR CONTROL SYSTEMS

(71) Applicant: Basler AG, Ahrensburg (DE)

(72) Inventor: Jens Dekarz, Bad Oldesloe (DE)

(21) Appl. No.: 17/208,982

(22) Filed: Mar. 22, 2021

(30) Foreign Application Priority Data
Mar. 24, 2020 (DE) 10 2020 108 070.0

(51) Int. Cl. G06F 21/55; G06F 21/56; G06F 11/22; G06F 11/07; G06F 11/30

(52) U.S. Cl. CPC G06F 21/552; G06F 21/554; G06F 21/568; G06F 2221/034; G06F 11/0766; G06F 11/3051; G06F 11/22

(57) ABSTRACT

A system and method are provided for monitoring the operational status of a computer system and/or control system. The method includes detecting at least one time-variable signal in the computer system and/or control system and forwarding it to a hardware module operating independently of the computer system and/or control system. The method also includes forming a summary statistics of the signal by the hardware module over a predetermined period of time and checking an extent of the summary statistics relative to a normal state and/or nominal state of the computer system and/or control system. The method also includes evaluating an operating state of the computer system and/or control system based on the checking.

### CROSS-REFERENCE TO RELATED APPLICATIONS

The invention relates to monitoring computer systems and/or control systems for abnormal operating conditions or malicious attacks.

### BACKGROUND

When DOS computer viruses began to spread at the end of the 1980s through the exchange of infected programs or floppy disks between computers, the first virus scanners were soon sold that could detect known viruses using signatures (“wanted posters”) of their program code. This still left open the possibility of being attacked by a virus that the virus scanner did not yet know about. As a result, heuristic antivirus programs were soon available, such as Ross Greenberg's “Flu-Shot Plus”, which monitored disk accesses and other programs' attempts to become memory resident (Terminate and Stay Resident, TSR) under DOS. In case of suspicious activities, such as write accesses to other programs, a confirmation of the user was requested.

The virus authors therefore upgraded their viruses so that they carried out their activities by bypassing software monitoring or completely disabling the antivirus program. Therefore, in the early 1990s, various plug-in cards with antivirus functionality for PCs were sold under names such as “Thunderbyte”, “Virustrap”, “V-Card” or “C:Cure” (Computerworld, 25 Jan. 1993, page 33). These plug-in cards were already active before the start of the DOS operating system and could not be prevented from functioning by software interventions. The plug-in cards were also looped into the connection between the hard disk controller and the hard disk, so that the data traffic to and from the hard disk could be monitored without gaps.

PC systems currently require a permanent supply of security updates and signatures for the anti-virus software in order to at least be armed against generally circulating attacks. For computer systems rolled out en masse or control systems in the “Internet of Things” (IoT), such a maintenance effort is hardly manageable.

### Objective of the Invention

It is therefore the objective of the invention to monitor the operational status of a computer system and/or control system in a manner that is difficult for malicious attackers to circumvent, while at the same time not relying on a constant supply of updates.

This objective is achieved by the present invention by a method according to the main claim, a hardware module according to a further independent claim and by a camera module, sensor module and/or actuator module according to a further independent claim. Further advantageous embodiments are detailed in the dependent claims referring back thereto.

### Disclosure of the Invention

In the context of the invention, a method for monitoring the operating state of a computer system and/or control system has been developed. In this context, in particular, any system which executes machine-readable instructions in order to perform its function is to be regarded as a computer system and/or control system.

The method begins with detecting at least one time-varying signal in the computer system and/or control system and forwarding the signal to a hardware module operating independently of the computer system and/or control system. A summary statistics of the signal is formed by the hardware module over a predetermined period of time. A check is now made as to the extent to which the summary statistics are in accordance with a normal state and/or nominal state of the computer system and/or control system. From the result of this check, the operating state of the computer system and/or control system is evaluated.

In this context, the compilation of summary statistics in particular fulfils a dual function.

On the one hand, even a very large amount of accumulating raw data, such as is generated during hardware-related monitoring of bus lines or other communication links of the computer system and/or control system, is compressed in such a way that it can be further processed even with the limited resources of an additional independent hardware module. This hardware module is intended to be added to the respective system as an “add-on” and should therefore ideally not demand significantly more than the actual system to be monitored, both in terms of price and energy consumption.

On the other hand, the formation and evaluation of summary statistics also brings about a great power of generalization. In order to merely determine if the system is working properly, the type of deviations that may occur do not need to be known in advance. This is beneficial both for detecting attacks on the system and for detecting other malfunctions. Attacks often exploit “zero-day” vulnerabilities that are not yet known to the device manufacturer. Malfunctions are difficult to predict, especially with new IoT devices. For example, it's not always possible to predict with a “reefing test” which components in an IoT device will fail first due to wear and tear when the device is exposed to wind and weather for several years. Often, it is only after a few years and a sufficient number of devices have failed that it becomes obvious what the device's “Achilles heel” is (such as a particular capacitor or semiconductor that was undersized for the stress). A reefing test is a test in which a device is stressed many times more intensively than in normal operation with the aim of predicting the condition of the device after long-term to many-year use within a comparatively short period of time.

Especially for the maintenance of a larger installed base of IoT devices, even the binary information whether the respective device is working completely properly or not is very valuable. Such devices are often used in the context of traffic control systems, surveillance cameras, and climate monitoring stations, for example, in locations that are difficult to access. For example, a maintenance operation can then be planned if three of five devices have a fault, so that a cherry picker or industrial climber does not have to be called out for every single fault.

In a particularly advantageous embodiment, the time-varying signal comprises
at least one electrical signal from an electrical circuit of the computer system and/or control system, and/or
at least one measurement signal detected in the computer system and/or control system, and/or
at least one stream of events output by the computer system and/or control system.

In particular, directly tapped electrical signals and measurement signals cannot or can only with difficulty be specifically influenced or falsified by software running on the computer system and/or control system in such a way that a normal state is simulated. But even a stream of events generated by the operating system, for example, is comparatively difficult to “bend” completely to a normal state or nominal state.

In a particularly advantageous embodiment, the electrical signal is sensed on at least one address bus, at least one data bus, at least one control bus, and/or at least one other communication link of the computer system and/or control system. In particular, the aforementioned bus connections often traverse the entire system, so that a large part of the overall activities taking place in the system can be monitored with a single tap of the signal. However, this is also accompanied by the fact that, due to the high clock rates on these bus connections, very high data rates are generated when the signal is acquired. In this context, it is again particularly advantageous that the data is highly compressed and condensed when the summary statistics are formed.

A deviation from the normal state and/or nominal state does not necessarily have to be characterized by the fact that certain unusual activities take place as an alternative to or in addition to expected activities. Rather, the absence of expected activities can also indicate that the system is not currently performing its function, for example because a hardware component has failed or the software has “hung up”.

Particularly advantageously, the hardware module interprets at most one physical layer of a communication protocol when forming the summary statistics. This may in particular be, for example, the communication protocol used on said communication link. That is, the electrical signal tapped from the communication link is decoded into a data stream comprising bits and/or data symbols, but this data stream is not further processed into logical data packets or more complex data structures composed of such data packets. Interpreting only the physical layer can be accomplished with simple, specialized receiving hardware implementable, for example, on a field programmable gate array (FPGA). At the same time, merely reconstructing the data stream does not yet provide a target for a malicious attack on the hardware module used for monitoring. In order to impose his will on this hardware module, or the software implemented on it, the attacker would have to present the hardware module with information that specifically violates at least one of the protocols intended for the communication link and confront the software with a situation that was not foreseen during its implementation. For example, if a data packet of a certain length is announced and is followed by a much longer data packet, the software responsible for processing the data packet may have set itself up for the announced length and be overwhelmed by a buffer overflow. Such targeted violations cannot yet be accommodated in the “naked” data stream of the physical layer.

In a further particularly advantageous embodiment, the measurement signal includes a supply voltage of the computer system and/or control system, and/or a temperature measured in the computer system and/or control system. The temporal course of the supply voltage allows conclusions to be drawn about the power consumption of the system or one of its components. This in turn provides information about the actions performed by the system, or component. This is somewhat analogous to “side-channel attacks”, in which sensitive information, such as cryptographic keys, is extracted from fluctuations in power consumption.

The same applies to the temperature. If the system is much busier than it should be because a ransomware is encrypting the data, the temperature will rise. Hardware problems can also cause the temperature to rise. For example, a failed fan can cause a build-up of heat, or a defective component can heat up more due to an increased current flow. A noticeably low temperature, on the other hand, can indicate, for example, that the system has stopped working altogether due to stalled software or that the housing is damaged and cold is penetrating unhindered from the outside.

The summary statistics may include, for example, histograms, means, medians, standard deviations, and other statistical evaluations of any characteristics formed from the temporal evolution of the signal. In a particularly advantageous embodiment, the summary statistics include a measure of a workload of the computer system and/or control system. As previously mentioned, an unusually high utilization may indicate undesirable activity, while an unusually low utilization may indicate that the system has stopped functioning altogether. Utilization is a particularly insightful parameter in this regard, for which at least an estimate can be provided if the normal activities of the system are known. Finally, in the case of IoT devices in particular, in the interest of the best possible energy efficiency and low manufacturing costs, the hardware is dimensioned precisely in such a way that the device can perform the intended task, but no capacity is left idle.

In particular, for example, a change in utilization at a temporal rate that meets a predetermined criterion may be considered indicative of an abnormal operating condition. For example, a sudden increase in load may indicate malware activity, while a sudden decrease may indicate a functional failure. Changes with a slower temporal rate can be explained by, for example, diurnal fluctuations or an increasing trend in the number of requests to the computer system and/or control system.

As previously explained in many examples, the operating state may be evaluated purely passively from the behavior of the computer system and/or control system without any modification to that system itself. However, in a further particularly advantageous embodiment, the computer system and/or control system may be modified to alter the time-varying signal upon specified events and/or system states. These changes can then be used to directly infer the event and/or system state. Thus, the system can “Morse” the event or system state to the hardware module used for monitoring in such a way that it is difficult for the transmission to be corrupted or suppressed by malware running on the system.

In response to the evaluation of the operating condition indicating at least one anomaly, for example, at least one of the following actions may be performed:

an alarm is issued;

the computer system or control system is switched off, restarted or reset to factory settings;

a software update is installed on the computer system or control system;

the computer system or control system is caused to output operational data, log data and/or diagnostic information;

the computer system or control system is caused to protect important data from being lost by sending it via a communication interface;

the computer system or control system is caused to protect confidential data from disclosure by deleting it;

the computer system or control system is put into emergency operation;

a self-test of the computer system or control system is initiated; and/or

a self test of the hardware module is initiated.

In particular, many malfunctions can be eliminated automatically without human intervention, for example by restarting, resetting to factory settings and/or importing a software update. This is particularly advantageous for the IoT devices mentioned at the beginning, which are operated in locations that are difficult to access.

Self-tests and the sending of diagnostic information may not completely eliminate the need for maintenance work on the system, but can at least simplify it. In particular, this information can indicate, for example, which spare parts are needed.

Sending important data, or deleting confidential data, is also particularly advantageous for devices in hard-to-reach locations. For example, if such a device is tampered with in order to steal it, it is unlikely to be possible to remotely prevent the device from being taken. By the time a security guard or the police arrive, the device will be long gone. So the device can only help itself in terms of data.

In a particularly advantageous embodiment, the described actions are exerted by the hardware module on the computer system and/or control system via a unidirectional communication interface. In this way, malware running on the system cannot use this interface to interfere with the function of the software implemented on the hardware module. For example, if the hardware module were to expect feedback from the computer system and/or control system about the intervention, the malware could attempt to use an invalidly formatted or otherwise manipulated feedback message to create a special case not intended in the software implemented on the hardware module and impose its will on the software running in the hardware module's memory through buffer overflow or similar attacks.

In a particularly advantageous embodiment, the time-variable signal is passively read out from the computer system and/or control system by the hardware module. This means that the system itself is unaware of this readout. Thus, a malware in the system cannot specifically “go dormant” in response to the monitoring by the hardware module being active in order to avoid detection.

In a further particularly advantageous embodiment, the summary statistics, and/or at least one parameter characterizing these summary statistics, are transmitted from the hardware module to an external server. Checking the extent to which the summary statistics are in accordance with a normal state and/or nominal state of the computer system and/or control system is then performed, at least in part, on the external server. This allows the use of more sophisticated methods, such as machine learning methods, for the checking. Such methods cannot always be implemented on the hardware module. For example, a hardware module that is part of a battery-powered IoT device has limited computing power and energy resources available. Also, for example, implementing the hardware module as an FPGA limits the resources available for testing and further evaluation of the operating state. The external server, on the other hand, can make use of the full instruction set of a general purpose computer. Further, an external server may also be used to implement centralized management of a plurality of computer systems and/or control systems. Thus, for example, it may be possible to monitor whether a fault is spreading within a large installed base of devices, which may indicate a coordinated attack or even a worm-like spread of malware.

For the check on the external server, in addition to machine learning methods, any other methods of classical signal processing can be used, for example. In particular, the test can, for example, be at least partially self-learning, i.e., automatically adapt to changes in the summary statistics. In particular, it is useful, for example, to distinguish between different time scales in order to be able to detect both rapid, one-off changes and long-term deviations. As a result of the test, parameters of the method according to which the time-varying signal is condensed to the summary statistics can in particular also be adapted, for example. In particular, time constants of this compression can be modified, such as the length of time intervals (“bins”) with which the signal is discretized in time.

The external server also has additional information for the test that is not available to the hardware module. For example, not every sudden increase in system load is atypical per se. Many demand spikes can be explained by external events that are known to the external server. For example, water and power utilities have been known to experience sudden spikes in demand during halftime of important football games. This may be reflected in the workload of IoT devices in such utility systems. Also, for example, the introduction of a new smartphone in a keynote presentation can trigger a sudden rush of orders to a computer system of an online shop.

In a further particularly advantageous embodiment, summary statistics from a plurality of computer systems and/or control systems are combined on the external server for checking the extent to which the summary statistics are in accordance with a normal state and/or nominal state of the computer system and/or control system. In particular, this enables, for example, a check of whether changes in the summary statistics of multiple systems occur at exactly the same time or are delayed with respect to each other. For example, if multiple IoT devices physically observing the same scene show changes in the summary statistics at exactly the same time, then this indicates that the changes are caused by events or changes in the observed scene itself. On the other hand, if the changes appear to spread successively across an installed base of devices, this may indicate that the devices are being attacked one by one, or even that a malware is spreading successively from device to device in a worm-like fashion. This is especially true, for example, when changes within an installed base of devices also spread between devices that are installed in completely different locations and collect completely different metrics.

In response to the determination that the computer system and/or control system is not in the normal state and/or nominal state, the external server can initiate a logistical action, such as a service call and/or a device replacement at the location of the computer system and/or control system. In particular, this may be dovetailed with existing logistic systems so that, for example, service calls to IoT devices that are spatially close to each other are clustered. The automated planning of logistical measures can also include predictive maintenance, for example. For example, if an IoT device in a hard-to-reach location needs to be serviced or replaced and, based on a history registered by the central server, it is expected that a neighboring device in the same location will also fail soon due to wear and tear, then it may make sense to service that device as well. Doing so will “give away” some remaining lifetime of that unit. However, this can be much cheaper than, for example, hiring a new cherry picker or using an industrial climber again on the day the equipment fails.

In another particularly advantageous embodiment, a behavior, and/or an operational status, of software updates installed on the computer system and/or control system is evaluated from the summary statistics. Any such update fundamentally involves the possibility that unexpected problems may occur thereafter. Therefore, for systems not yet connected to external networks, such as the Internet, the principle of “never change a running system” has often been applied. For networked systems, regular updates are unavoidable. By evaluating the behavior of the updates as part of the procedure, any problems that may occur when the updates are rolled out can be detected at an early stage. It is possible that such problems only become apparent under certain conditions and are therefore not detected during pre-tests before the roll-out.

In a further particularly advantageous embodiment, a summary statistics of the signal, and/or at least one parameter characterizing this summary statistics, is learned in a normal state and/or nominal state of the computer system and/or control system and is used for subsequent checks as to the extent to which a normal state and/or nominal state is present. In this way, a comparison with the normal state and/or nominal state becomes possible without criteria for this first having to be formulated manually in rules.

In a further advantageous embodiment, the result of checking the extent to which the summary statistics are in accordance with a normal state and/or nominal state of the computer system and/or control system is indicated to an operator. An input of the system state, and/or an action to be taken on the computer system and/or control system, is requested from the operator. In this way, the knowledge present in the hardware module and/or on the external server as to which changes in the behavior of the system are still to be considered normal and/or nominal and what action should be taken in the event of deviations can be supplemented with the knowledge of the operator.

The computer system and/or control system may in particular be a camera module, a sensor module or an actuator module. When using these modules, it is often required that they operate autonomously over a long period of time. Furthermore, these modules are often installed in locations that are difficult to access.

The invention also relates to a hardware module for monitoring the operational status of a computer system and/or control system. This hardware module comprises
a signal interface for detecting at least one time-variable signal of the computer system and/or control system,
a compression unit for forming summary statistics of the signal, and
a test unit adapted to test the extent to which the summary statistics are in accordance with a normal state and/or nominal state of the computer system and/or control system, and/or
a service interface different from the signal interface, which is designed to transmit the summary statistics, and/or a parameter characterizing these summary statistics, to an external server.

As previously explained in connection with the method, this hardware module can be used to monitor the extent to which the state of the respective system changes and possibly leaves the framework of the normal or nominal, while avoiding dependencies on the computer system and/or control system as far as possible.

The final evaluation of the operating state can be done within the hardware module, on the external server or in cooperation of the hardware module with the external server.

In a particularly advantageous embodiment, the hardware module comprises an evaluation unit. This evaluation unit obtains an analysis result from the test unit, and/or from the external server, as to the extent to which the summary statistics are in accordance with a normal state and/or nominal state of the computer system and/or control system. The evaluation unit is adapted to evaluate the operating state of the computer system and/or control system from this analysis result. This evaluated state can then be used, for example, by the hardware module to act on the computer system and/or control system. In this way, the elimination of a possibly detected problem can also be approached in an at least partially autonomous and automated manner.

To this end, in a particularly advantageous embodiment, the hardware module comprises a system interface different from the signal interface and the service interface for acting on the computer system and/or control system based on the evaluated operating state. For example, this signal interface may be coupled to signal inputs to the system that trigger a restart or shutdown of the system. However, more complex actions on the system may also be triggered. For example, a signal input of the system can be controlled via the signal interface, which in turn is queried by the software of the system.

In a particularly advantageous embodiment, the system interface is designed for unidirectional communication from the hardware module to the computer system and/or control system. As previously explained, the system interface cannot then be misused to impair the function of the software implemented on the hardware module by playing back invalid information.

According to what has been previously described, the invention also relates to a camera module, sensor module and/or actuator module that is equipped with the previously described hardware module and/or is pre-equipped with an FPGA device. If an FPGA module is present, it is integrated in the camera module, sensor module and/or actuator module in terms of circuitry in such a way that it can be made into the previously described hardware module, and/or into any other module suitable for carrying out the previously described method, by programming. An FPGA module is a standard module available on the market, which can be integrated into the camera module, sensor module and/or actuator module in terms of production technology at low cost. If the described monitoring with the hardware module is offered, for example, as an option for the camera module, sensor module and/or actuator module, the respective module can be supplied with the FPGA module regardless of whether the option was also purchased. This saves the expense of manufacturing two different versions of the product, which may well be more expensive than the value of the FPGA device itself. For those modules for which the monitoring option has been purchased, it can be activated by programming the FPGA device.

The method may be implemented in program code. Similarly, the hardware module may be implemented in code that provides the functionality of the hardware module to an FPGA device. The invention therefore also relates to a computer program comprising
machine-readable instructions which, when executed on one or more computers, cause the computer or computers to perform the method described above; and/or
a machine-readable configuration which, when introduced into an FPGA device, configures the FPGA device into the hardware module described above, and/or into any other module suitable for carrying out the method described above.

Similarly, the invention also relates to a machine-readable non-transitory storage medium, and/or a download product, comprising the computer program.

### DESCRIPTION OF THE FIGURES

Hereinafter, the subject matter of the invention will be explained with reference to figures without limiting the subject matter of the invention herein. It is shown:

FIG. 1: Exemplary embodiment of the process 100;

FIG. 2: Example of a system 1 with integrated hardware module 3;

FIG. 3: Example of a hardware module 3.

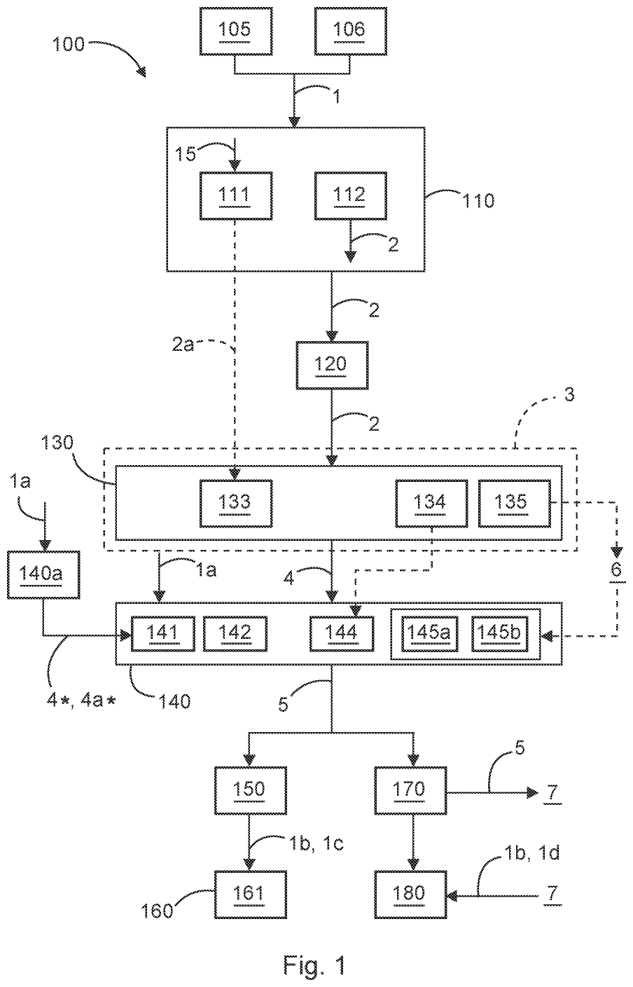

FIG. 1 is a schematic flowchart of an embodiment of the method 100 for monitoring the operating state 1b of a computer system and/or control system 1. According to block 105, the computer system and/or control system 1 may be modified to change a time-variable signal 2 detectable in or at the computer system and/or control system 1 upon specified events and/or system states. According to block 106, the computer system and/or control system 1 may be a camera module, a sensor module, and/or an actuator module.

In step 110, at least one time-varying signal 2 is detected in the computer system and/or control system 1. This time-variable signal 2 may, for example, comprise
at least one electrical signal 2a from an electrical circuit of the computer system and/or control system 1, and/or
at least one measurement signal 2b detected in the computer system and/or control system 1, and/or
at least one stream of events 2c output by the computer system and/or control system 1.

For example, an electrical signal 2a may be detected according to block 111 at a communication link 15 in the computer system and/or control system 1, such as an address bus, data bus, and/or control bus.

Generally, according to block 112, the time-varying signal 2 may be passively sensed so that the computer system and/or control system 1 is unaware of such sensing.

The time-varying signal 2 is supplied in step 120 to a hardware module 3 that operates independently of the computer system and/or control system. A summary statistics 4 of the signal 2 is formed by the hardware module 3 over a predetermined period of time in step 130.

In step 140, the extent to which the summary statistics 4 are in accordance with a normal state and/or nominal state la of the computer system and/or control system 1 is checked. From the result 5 of this check 140, the operating state 1b of the computer system and/or control system 1 is evaluated in step 150.

Within box 130, various exemplary ways in which summary statistics 4 may be determined are provided.

According to block 133, at most one physical layer of the communication protocol used on the communication link 15 may be interpreted by the hardware module 3 when forming the summary statistics 4.

According to block 134, the summary statistics 4 may include a measure of a workload of the computer system and/or control system 1. Pursuant to block 144, the test 140 may then evaluate, for example, a change in the workload at a rate over time that meets a predetermined criterion as indicative of an abnormal operating condition 1b.

According to block 135, the summary statistics 4, and/or at least one characteristic 4a characterizing these summary statistics 4, may be transmitted from the hardware module 3 to an external server 6. The check 140 may then be performed according to block 145, at least in part, on the external server 6. In this regard, again in accordance with block 145a, summary statistics 4 from a plurality of computer systems and/or control systems 1 may be combined on the external server 6. Alternatively, or in combination, in response to a determination that the computer system and/or control system 1 is not in the normal state and/or nominal state 1a, the external server 6 may, in accordance with block 145b, initiate a logistical action to correct the problem.

According to block 140a, in order to prepare the matching of the summary statistics 4 with the normal state and/or nominal state 1a, for example, in such a normal state and/or nominal state 1a, a summary statistics 4* of the signal 2, and/or at least one characteristic quantity 4a* characterizing this summary statistics 4*, may be learned. In the context of the test 140, this summary statistics 4*, and/or this characteristic quantity 4a*, may be used.

Further, according to block 142, a behavior, and/or an operational status, of software updates installed on the computer system and/or control system 1 may be evaluated from the summary statistics 4.

In response to the evaluation 150 of the operating state 1b indicating at least one anomaly 1c, various actions may be triggered in step 160. Here, according to block 161, the computer system and/or control system 1 may be acted upon by the hardware module 3 via a unidirectional communication interface 38.

The check result 5 may also be displayed to an operator 7 in step 170, and in step 180 an input of the system state 1b, and/or an action 1d to be taken on the computer system and/or control system, may be requested from the operator 7.

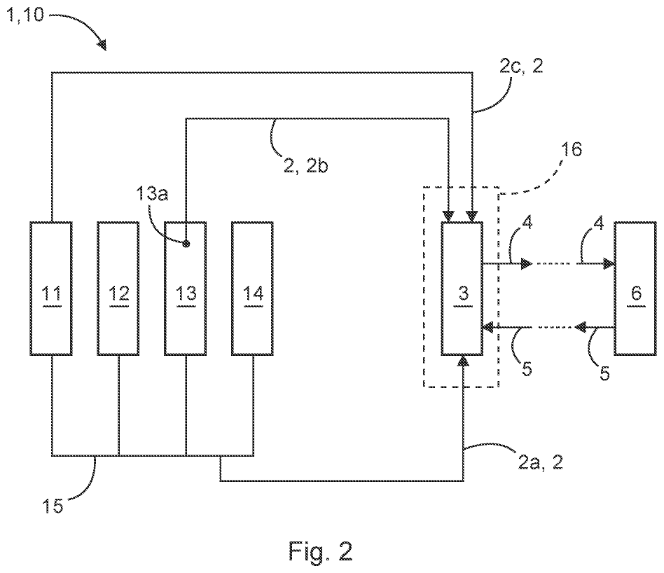

FIG. 2 shows an embodiment of a computer system and/or control system 1, which may for example be a camera module, sensor module and/or actuator module 10. The computer system and/or control system 1 comprises a processor 11, a memory 12, an input-output controller 13 and other peripheral devices 14, all coupled via a bus 15. In addition, an FPGA device 16 is provided, through the programming of which the hardware module 3 is implemented.

In the example shown in FIG. 2, the hardware module 3 receives an electrical signal 2a from the bus 15, a measurement signal 2b from a temperature sensor 13a on the input-output controller 13, and a stream 2c of events as time-varying signals 2 from the processor 11. The hardware module 3 forms summary statistics 4 on these signals 2 and sends them to an external server 6, and the external server 6 responds thereto with analysis result 5 as to the extent to which the summary statistics 4 are in accordance with a normal state and/or nominal state la of the computer system and/or control system 1.

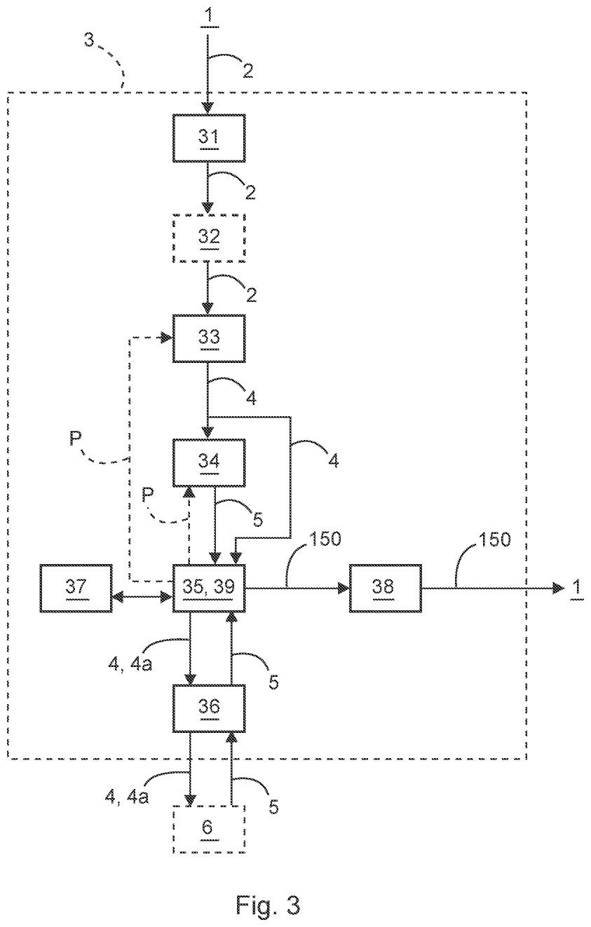

FIG. 3 shows an embodiment of the hardware module 3. The hardware module 3 has a signal interface 31 via which it can pick up time-variable signals 2 from the computer system and/or control system 1. Here, in particular, receiving hardware 32 may be provided, for example, to interpret the physical layer of communication protocols. A compression unit 33 is adapted to form summary statistics 4 on the signal 2.

A test unit 34 is adapted to test to what extent the summary statistics 4 is in accordance with a normal state and/or nominal state la of the computer system and/or control system 1. In the example shown in FIG. 3, a service interface 36 different from the signal interface 31 is additionally provided and adapted to transmit the summary statistics 4, and/or a characteristic 4a characterizing these summary statistics 4, to an external server 6.

Analysis results 5, which are supplied by the test unit and/or by the external server 6, are fed to a control unit 35. In the example shown in FIG. 3, the control unit 35 also functions as an evaluation unit 39 which evaluates the operating state 1b of the computer system and/or control system 1 from the analysis results 5. The control unit 35 can, for example, trigger the described actions 150 by acting on the computer system and/or control system 1 via a unidirectional system interface 38 that is different from the signal interface 31 and the service interface 36. The control unit 35 accesses a memory 37 and may in turn modify parameters P characterizing the behavior of the compression unit 33, and/or the behavior of the test unit 34.

### LIST OF REFERENCE SIGNS

1 Computer system and/or control system

1a Normal and/or nominal state of the system 1

1b Operating status of the system 1

1c Anomaly of the operating condition 1b

1d Take action to correct problem on system 1

10 Camera module, sensor module and/or actuator module as system 1

11 Processor of the system 1

12 Memory of system 1

13 Input/output controller of system 1

14 Other peripheral devices of system 1

15 Communication connection in system 1

16 FPGA device in system 1

2 Time-variable signal detected in system 1

2a electrical signal as time-variable signal 2

2b measuring signal as time-variable signal 2

2c stream of events as time-variable signal 2

3 hardware module

31 signal interface of the hardware module 3

32 receiving hardware for physical protocol level

33 compression unit for forming statistics 4

34 test unit for adjustment with normal condition/nominal condition 1a

35 control unit of the hardware module 3

36 service interface of the hardware module 3

37 memory of the hardware module 3

38 system interface of the hardware module 3

39 evaluation unit of the hardware module 3

4 summary statistics of the time-varying signal 2

4a characteristic parameter, characterizes statistics 4

4* learning statistics, recorded in normal state/nominal state 1a

4a* characteristic of the learning statistics 4*

5 Analysis result from comparison of statistics 4 with state 1a

6 external server

7 operator

100 method for monitoring the operating condition 1b

105 modifying system 1 for monitoring

106 selecting a camera module, sensor module and/or actuator module

110 sensing the time-varying signal 2

111 sensing the electrical signal 2a on the connection 15

112 passive reading of signal 2 from system 1

120 forwarding the time-variable signal 2 to hardware module 3

130 forming of summary statistics 4

133 interpreting a maximum of one physical protocol layer

134 creating a statistics 4 with a measure of utilization

135 sending statistics 4/characteristic 4a to external server 6

140 matching statistics 4 with normal state/nominal state la

140a learning the learning statistics 4* and/or characteristic 4a*

141 using the learning statistics 4* and/or the characteristic 4a*

142 evaluating the behavior of updates

144 considering the rate of change of the workload over time

145 outsourcing test 140 to external server 6

145a merging statistics 4 from several systems 1

145b initiating a logistic action by the server 6

150 evaluating the operating status 1b

160 reaction to anomaly 1c in operating state 1b

161 acting upon system 1 via unidirectional interface 38

170 displaying the analysis result 5 to operator 7

180 requesting state 1b, action 1d from operator 7

1. A method for monitoring the operational status of a computer system and/or control system comprising the steps:
detecting at least one time-variable signal in the computer system and/or control system and forwarding it to a hardware module operating independently of the computer system and/or control system;
forming summary statistics of the signal by the hardware module over a predetermined period of time;
checking to what extent the summary statistics are in accordance with a normal state and/or nominal state of the computer system and/or control system;
evaluating an operating state of the computer system and/or control system using: at least a result of the checking to what extent the summary statistics are in accordance with a normal state and/or nominal state of the computer system and/or control system.

2. The method according to claim 1, wherein the at least one time-varying signal includes:
at least one electrical signal from an electrical circuit of the computer system and/or control system, and/or
at least one measurement signal detected in the computer system and/or control system, and/or
at least one stream of events output by the computer system and/or control system.

3. The method according to claim 2, further comprising detecting the electrical signal on at least one address bus, at least one data bus, at least one control bus, and/or at least one other communication link of the computer system and/or control system.

4. The method according to claim 1, wherein forming the summary statistics includes interpreting, by the hardware module, at most one physical layer of a communication protocol.

5. The method according to claim 2, wherein the measurement signal comprises a supply voltage of the computer system and/or control system, and/or a temperature measured in the computer system and/or control system.

6. The method according to claim 1, wherein the summary statistics include a measure of a workload of the computer system and/or control system.

7. The method according to claim 6, further comprising determining a change in the workload of the computer system and/or control system at a temporal rate satisfying a predetermined criterion to be indicative of an abnormal operating condition.

8. The method according to claim 1, wherein further comprising modifying the computer system and/or control system to change the time-varying signal upon specified events and/or system states.

9. The method according to claim 1, further comprising, in response to the evaluating of the operating condition not indicating that the summary statistics are in accordance with the normal state and/or nominal state of the computer system and/or control system, determining at least one anomaly and further comprising performing at least one of the following actions:
issuing an alarm;
switching off or restarting the computer system and/or control system, or resetting the computer system and/or control system to factory settings;
installing a software update on the computer system or control system;
causing the computer system and/or control system to output operational data, log data, and/or diagnostic information;
causing the computer system and/or control system to send important data over a communication interface to protect the important data from being lost;
causing the computer system and/or control system to delete confidential data to protect the confidential data from disclosure;
causing the computer system and/or control system to enter into an emergency operation mode;
initiating a self-test of the computer system and/or control system; and/or
initiating a self test of the hardware module.

10. The method according to claim 9, further comprising causing the hardware module to act upon the computer system and/or control system via a unidirectional communication interface.

11. The method according to claim 1, wherein the hardware module is further configured to passively read out the time-varying signal from the computer system and/or control system.

12. The method according to claim 1, further comprising transmitting the summary statistics, and/or at least one parameter characterizing said summary statistics from the hardware module to an external server and wherein checking the extent to which the summary statistics is in accordance with a normal state and/or nominal state of the computer system and/or control system is performed at least in part on the external server.

13. The method according to claim 12, further comprising merging, on the external server summary statistics from a plurality of computer systems and/or control systems for checking to what extent the summary statistics are in accordance with a normal state and/or nominal state of the computer system and/or control system.

14. The method according to claim 1, wherein the external server, in response to determining that the computer system and/or control system is not in the normal state and/or nominal state, initiates a logistical action including at least one of a service call and/or equipment replacement at the location of the computer system and/or control system.

15. The method according to claim 12, further comprising evaluating, from the summary statistics a behavior, and/or an operational state, of software updates installed on the computer system and/or control system.

16. The method according to claim 1, wherein, in a normal state and/or nominal state of the computer system and/or control system, a summary statistics of the signal, and/or at least one characteristic variable characterizing this summary statistics, is learned and used for subsequent checks as to whether a normal state and/or nominal state is present.

17. The method according to claim 1, further comprising indicating a result of checking to what extent the summary statistics are in accordance with a normal state and/or nominal state of the computer system and/or control system to an operator, and requesting from the operator an input of the system state, and/or an action to be taken on the computer system and/or control system.

18. The method according to claim 1, wherein the computer system and/or control system includes at least one of a camera module, a sensor module, and/or an actuator module.

19. A hardware modules for monitoring the operating state of a computer system and/or control system, comprising
a signal interface for detecting at least one time-variable signal of the computer system and/or control system,
a compression unit for forming summary statistics on the signal, and
a test unit adapted to test the extent to which the summary statistics are in accordance with a normal state and/or nominal state of the computer system and/or control system, and/or
a service interface different from the signal interface, which is designed to transmit the summary statistics, and/or a characteristic variable characterizing these summary statistics, to an external server.

20. The hardware module according to claim 19, further comprising an evaluation unit configured to evaluate the operating state of the computer system and/or control system from an analysis result obtained from the test unit and/or from the external server, to what extent the summary statistics are in accordance with a normal state and/or nominal state of the computer system and/or control system.

21. The hardware module according to claim 20, further comprising a system interface different from the signal interface and the service interface for acting on the computer system and/or control system based on the evaluated operational state.

22. The hardware module according to claim 21, wherein the system interface is configured for unidirectional communication from the hardware module to the computer system and/or control system.

23. A camera module, sensor module and/or actuator module with the hardware module according to claim 19, and/or with an FPGA module which is integrated in the camera module, sensor module and/or actuator module in terms of circuitry in such a way that it is programmable to become said hardware module, or another module suitable for carrying out the method of claim 1 is integrated into the hardware module.

24. A computer program, comprising machine-readable instructions that, when executed on one or more computers and/or an FPGA device cause the one or more computers, and/or the FPGA device, to execute a method comprising:
at least one time-variable signal in the computer system and/or control system, and forwarding to a hardware module operating independently of the computer system and/or control system;
forming summary statistics of the signal by the hardware module over a predetermined period of time:
checking to what extent the summary statistics are in accordance with a normal state and/or nominal state of the computer system and/or control system;
evaluating an operating state of the computer system and/or control system using at least a result of the checking of what extent the summary statistics are in accordance with a normal state and/or nominal state of the computer system and/or control system.

25. canceled

26. canceled
